(19) United States
(12) Patent Application Publication
(10) Pub. No.: US 2026/0316568 A1
(43) Pub. Date: Oct. 15, 2026

(54) IN-VEHICLE DEVICE, VEHICLE, NON-TRANSITORY STORAGE MEDIUM, AND SOURCE SWITCHING METHOD

(71) Applicant: TOYOTA JIDOSHA KABUSHIKI KAISHA, Toyota-shi (JP)

(72) Inventor: Takashi HATTORI, Kasugai-shi (JP)

(73) Assignee: TOYOTA JIDOSHA KABUSHIKI KAISHA, Toyota-shi (JP)

(21) Appl. No.: 19/467,463

(22) Filed: Feb. 2, 2026

(30) Foreign Application Priority Data
Feb. 6, 2025 (JP) 2025-018762

(51) Int. Cl. B60K 35/29; B60K 35/10

(52) U.S. Cl. CPC B60K 35/29; B60K 35/10

(57) ABSTRACT

An in-vehicle device installed in a vehicle includes a processor configured to: switch a source in a switching order set in advance each time a single operation of a physical switch mounted on the vehicle is detected; output a content of the source via an output device mounted on the vehicle; and when switching the source, skip a source that has no outputtable content.

### CROSS-REFERENCE TO RELATED APPLICATION

This application claims priority to Japanese Patent Application No. 2025-018762 filed on Feb. 6, 2025. The disclosure of the above-identified application, including the specification, drawings, and claims, is incorporated by reference herein in its entirety.

### BACKGROUND

### 1. Technical Field

The present disclosure relates to an in-vehicle device, a vehicle, a non-transitory storage medium, and a source switching method.

### 2. Description of Related Art

Japanese Unexamined Patent Application Publication No. 2013-179588 (JP 2013-179588 A) discloses a system that automatically switches a GUI displayed on a touch panel of a smartphone to one that matches the state of a television receiver. The term "GUI" is an abbreviation for "graphical user interface".

### SUMMARY

In a vehicle, it is conceivable to sequentially switch the source of a content such as audio or video using a physical switch such as a steering switch installed on a steering wheel. However, while such switching itself is easier than selecting a desired source on a screen, it is necessary to switch the source again when switching is made to a source that has no content that can be output, which may reduce convenience for a user.

The present disclosure provides an in-vehicle device, a vehicle, a non-transitory storage medium, and a source switching method that improves convenience for a user while allowing sequentially switching the source of a content using a physical switch in a vehicle.

A first aspect of the present disclosure provides an in-vehicle device installed in a vehicle, including a processor configured to:
switch a source in a switching order set in advance each time a single operation of a physical switch mounted on the vehicle is detected;
output a content of the source via an output device mounted on the vehicle; and
when switching the source, skip a source that has no outputtable content.

A second aspect of the present disclosure provides a source switching method of switching a source in an in-vehicle device, including:
switching the source in a switching order set in advance each time a single operation of a physical switch mounted on the vehicle is detected;
outputting a content of the source via an output device mounted on the vehicle; and
when switching the source, skipping a source that has no outputtable content.

According to the present disclosure, the source of a content can be sequentially switched using a physical switch in a vehicle, and convenience for a user is improved.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 illustrates the configuration of a system according to an embodiment of the present disclosure;

FIG. 2 illustrates an example of a physical switch according to the embodiment of the present disclosure;

FIG. 3 is a block diagram illustrating the configuration of an in-vehicle device and the connection of the in-vehicle device to various elements according to the embodiment of the present disclosure;

FIG. 4 illustrates an example of a selection screen according to the embodiment of the present disclosure;

FIG. 5 is a flowchart illustrating the operation of the in-vehicle device according to the embodiment of the present disclosure;

FIG. 6 is a flowchart illustrating a modification of the operation of the in-vehicle device according to the embodiment of the present disclosure; and

FIG. 7 is a flowchart illustrating a different modification of the operation of the in-vehicle device according to the embodiment of the present disclosure.

### DETAILED DESCRIPTION OF EMBODIMENTS

Hereinafter, an embodiment of the present disclosure will be described with reference to the drawings.

In the drawings, the same or corresponding portions are denoted by the same reference signs. In the description of the present embodiment, description of the same or corresponding components will be omitted or simplified as appropriate.

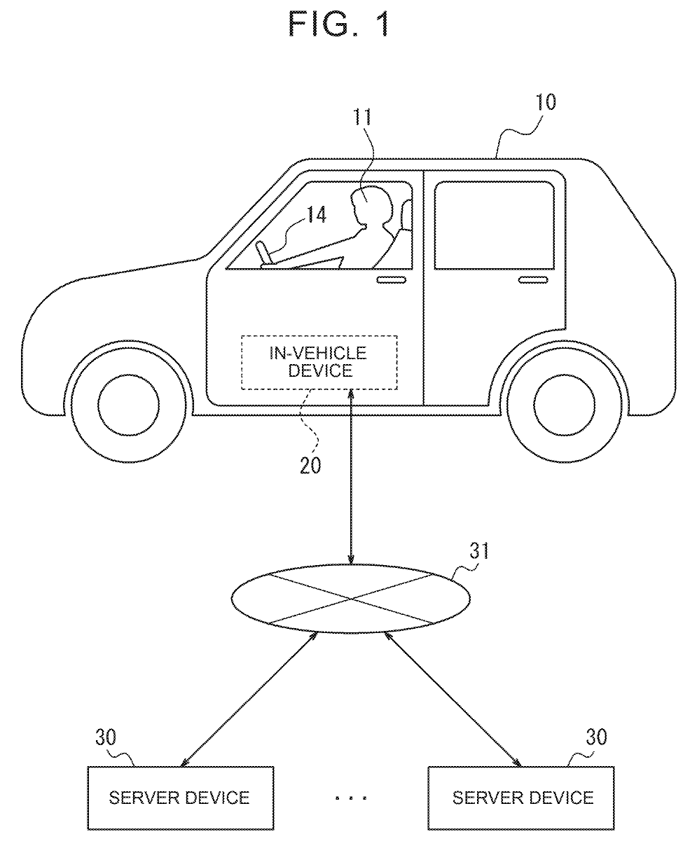

The configuration of a system according to the present embodiment will be described with reference to FIG. 1.

The system according to the present embodiment includes an in-vehicle device 20 installed in a vehicle 10 and one or more server devices 30 that provide one or more content distribution services. The in-vehicle device 20 is capable of communicating with the server devices 30 via a network 31.

The vehicle 10 is an automobile of any type, such as a gasoline vehicle, a diesel vehicle, a hydrogen vehicle, an HEV, a PHEV, a BEV, or an FCEV. The term "HEV" is an abbreviation for "hybrid electric vehicle". The term "PHEV" is an abbreviation for "plug-in hybrid electric vehicle". The term "BEV" is an abbreviation for "battery electric vehicle". The term "FCEV" is an abbreviation for "fuel cell electric vehicle". In the present embodiment, the vehicle 10 is driven by a user 11. However, the driving may be automated at any level. The level of autonomous driving is one of Levels 1 to 5 defined by the SAE, for example. The term "SAE" is an abbreviation for "Society of Automotive Engineers". The vehicle 10 may be a MaaS dedicated vehicle. The term "MaaS" is an abbreviation for "Mobility as a Service".

The in-vehicle device 20 is a computer such as a microcomputer or an ECU that is mounted on the vehicle 10. The term "ECU" is an abbreviation for "electronic control unit". The in-vehicle device 20 may function as an IVI terminal or a part of the IVI terminal. The term "IVI" is an abbreviation for "in-vehicle infotainment".

The server device 30 is a computer such as a cloud server installed in a facility such as a data center. In the present embodiment, there are two or more server devices 30, and each of the server devices 30 provides at least one content distribution service. That is, two or more server devices 30 provide a plurality of content distribution services as the entire system. In one modification, the number of server devices 30 may be one, and in such a modification, the single server device 30 provides a single or a plurality of content distribution services.

In the present embodiment, the content distribution services include one or more audio streaming services, one or more video streaming services, or both of these. An audio streaming service is a service that distributes an audio content such as music, audiobooks, podcasts, or radio. A video streaming service is a service that distributes a video content such as movies, dramas, or animations. For example, the content distribution services may be a plurality of OTT services. The term "OTT" is an abbreviation for "over-the-top" media service.

The network 31 includes the Internet, at least one WAN, at least one MAN, or any combination of these. The term "WAN" is an abbreviation for "wide area network". The term "MAN" is an abbreviation for "metropolitan area network". The network 31 may include at least one wireless network, at least one optical network, or any combination of these. The wireless network is, for example, an ad hoc network, a cellular network, a wireless LAN, a satellite communication network, or a terrestrial microwave network. The term "LAN" is an abbreviation for "local area network".

An overview of the present embodiment will be described with reference to FIG. 1.

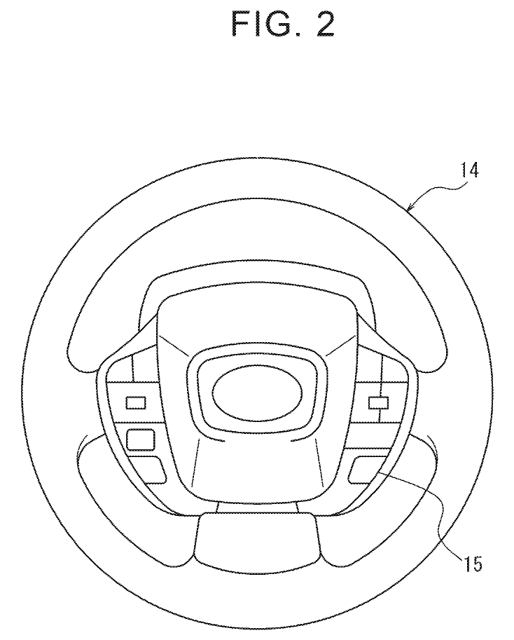

The in-vehicle device 20 switches a source in a switching order set in advance each time a single operation of a steering switch 15 installed on a steering wheel 14 of the vehicle 10 as illustrated in FIG. 2 is detected. The steering switch 15 may be a button switch, a toggle switch, a touch switch, or any other type of switch. The in-vehicle device 20 outputs a content of the source. In the present embodiment, the content includes a multimedia content. When switching the source, the in-vehicle device 20 skips a source that has no content that can be output. Thus, according to the present embodiment, it is possible not only to make the switching itself easy compared to selecting a desired source on a screen, but also to suppress switching to a source that has no content that can be output, improving convenience for the user 11.

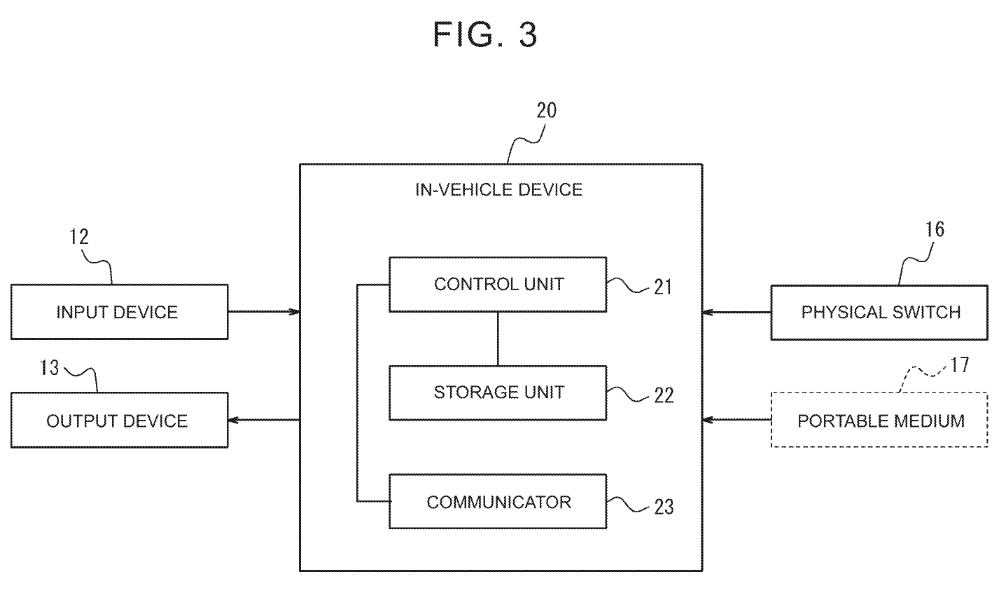

As illustrated in FIG. 3, in the present embodiment, the in-vehicle device 20 is connected to an input device 12, an output device 13, and a physical switch 16 mounted on the vehicle 10, and can be connected to a portable medium 17 brought into the vehicle 10 by the user 11.

The input device 12 is, for example, a physical key, a capacitive key, a pointing device, a touch screen integrated with a display, a camera, or a microphone.

The output device 13 is, for example, a display or a speaker. The display is, for example, an LCD or an organic EL display. The term "LCD" is an abbreviation for "liquid crystal display". The term "EL" is an abbreviation for "electroluminescent". The display may be a display audio.

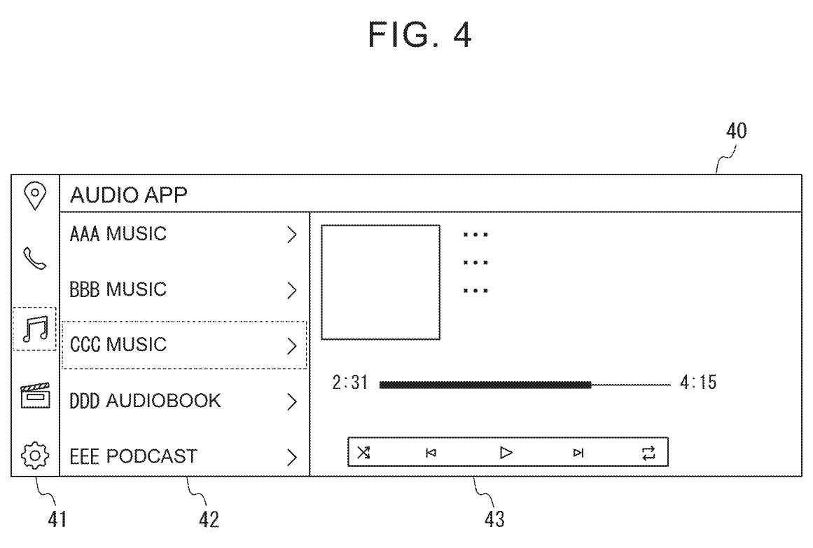

The in-vehicle device 20 displays a selection screen 40 as illustrated in FIG. 4 on the display. The selection screen 40 includes a category list 41, a source list 42, and content information 43.

When a category such as audio or video is selected from the category list 41, the in-vehicle device 20 displays a list of sources corresponding to the selected category on the display as the source list 42. When a source is selected from the source list 42, the in-vehicle device 20 automatically outputs a content of the selected source via the output device 13, and displays information about the content being output on the display as the content information 43. When the selected source has no content to be output automatically, the in-vehicle device 20 displays a list of contents of the selected source on the display as the content information 43. When a content is selected from the list of contents, the in-vehicle device 20 outputs the selected content via the output device 13 and displays information about the content being output on the display as the content information 43.

For example, when audio is selected from the category list 41 by a touch operation, the in-vehicle device 20 displays a list of audio streaming services such as AAA Music, BBB Music, CCC Music, DDD Audiobooks, and EEE Podcasts on the display as the source list 42. When CCC Music is selected from the source list 42 by a touch operation, the in-vehicle device 20 automatically plays a song distributed by CCC Music via the speaker and displays, on the display as the content information 43, song information such as title, artist name, and album name of the song being played, playback status such as elapsed time, total time, and progress bar, album artwork, playback mode, and other information. When there is no song to be automatically played on CCC Music, the in-vehicle device 20 displays a list of songs distributed by CCC Music on the display as the content information 43. When a song is selected from the list of distributed songs by a touch operation, the in-vehicle device 20 plays the selected song via the speaker and displays, on the display as the content information 43, song information of the song being played, playback status, album artwork, playback mode, and other information.

The physical switch 16 is a switch that can be operated simply by pressing, tilting, or tapping. In the present embodiment, the physical switch 16 is the steering switch 15 installed on the steering wheel 14 of the vehicle 10 as illustrated in FIG. 2. As a modification, the physical switch 16 may be a switch installed in a center console, a dashboard, the vicinity of a gear shift lever, a door panel, or an armrest of a seat of the vehicle 10. As another modification, the physical switch 16 may be a switch for a rear seat.

The in-vehicle device 20 switches the source in a switching order set in advance each time a single operation of the physical switch 16 is detected. The switching order may be set collectively for a plurality of categories, or may be set separately for each category. For example, the in-vehicle device 20 switches the source in a switching order corresponding to the categories each time a single operation of the physical switch 16 is detected. Alternatively, after a category is selected from the category list 41, the in-vehicle device 20 may switch the source in a switching order corresponding to the selected category each time a single operation of the physical switch 16 is detected. The in-vehicle device 20 outputs a content of the source via the output device 13. The in-vehicle device 20 may display information about the content being output on the display as the content information 43. In the present embodiment, when switching the source, the in-vehicle device 20 skips a source that has no content that can be output. As a modification, when switching the source, the in-vehicle device 20 may also skip a source that has no content to be output in response to a single-step operation or automatically. As another modification, the in-vehicle device 20 may also skip a source that has a content to be output in response to a single-step operation but has no content to be output automatically.

For example, it is assumed that the switching order is set in advance as follows: AAA Music first, BBB Music second, CCC Music third, DDD Audiobooks fourth, and EEE Podcasts fifth. Content distribution services other than audio streaming services, such as video streaming services, may be set as sixth or later. When a single operation of the steering switch 15 is detected while playing a song distributed by AAA Music, the in-vehicle device 20 switches to BBB Music and automatically plays a song distributed by BBB Music via the speaker. When BBB Music has no song to be played automatically but has a song that can be played, the in-vehicle device 20 displays a list of songs distributed by BBB Music on the display as the content information 43. When a song is selected from the list of distributed songs by a touch operation, the in-vehicle device 20 plays the selected song via the speaker. When there is no song that can be played on BBB Music, for example, when BBB Music is not subscribed to or the service of BBB Music has been suspended, the in-vehicle device 20 skips BBB Music and switches to CCC Music or a subsequent content distribution service. When there is no content that can be output from a content distribution service other than AAA Music, the in-vehicle device 20 continues playing the song distributed by AAA Music.

The portable medium 17 is, for example, a USB memory, an SD card, a portable audio player, a smartphone, an external HDD or SSD, a CD or DVD, a cassette tape, or a Bluetooth (registered trademark) transmitter device. The term "USB" is an abbreviation for "Universal Serial Bus". The term "SD" is an abbreviation for "Secure Digital". The term "HDD" is an abbreviation for "hard disk drive". The term "SSD" is an abbreviation for "solid-state drive". The term "CD" is an abbreviation for "compact disc". The term "DVD" is an abbreviation for "digital versatile disc".

The portable medium 17 may be included in the source list 42. For example, when audio is selected from the category list 41 by a touch operation, the in-vehicle device 20 may display a list that includes not only an audio streaming service but also a USB memory on the display as the source list 42. When a USB memory is selected from the source list 42 by a touch operation, the in-vehicle device 20 automatically plays a song in the USB memory via the speaker and displays, on the display as the content information 43, song information of the song being played, playback status, album artwork, playback mode, and other information. When there is no song to be played automatically in the USB memory, the in-vehicle device 20 displays a list of songs in the USB memory on the display as the content information 43. When a song is selected from the list of songs by a touch operation, the in-vehicle device 20 plays the selected song via the speaker and displays, on the display as the content information 43, song information of the song being played, playback status, album artwork, playback mode, and other information.

The portable medium 17 may be included in the switching order. For example, it is assumed that the switching order is set in advance as follows: AAA Music first, USB memory second, BBB Music third, CCC Music fourth, DDD Audiobooks fifth, and EEE Podcasts sixth. When a single operation of the steering switch 15 is detected while playing a song distributed by AAA Music, the in-vehicle device 20 switches to the USB memory and automatically plays a song in the USB memory via the speaker. When there is no song to be played automatically but there is a song that can be played in the USB memory, the in-vehicle device 20 displays a list of songs in the USB memory on the display as the content information 43. When a song is selected from the list of songs by a touch operation, the in-vehicle device 20 plays the selected song via the speaker. When there is no song that can be played in the USB memory, for example, when the USB memory is not inserted or is out of order, the in-vehicle device 20 skips the USB memory and switches to BBB Music or a subsequent content distribution service.

As an interface for connecting the in-vehicle device 20 to various elements such as the input device 12, the output device 13, the physical switch 16, and the portable medium 17, an interface that supports a standard such as USB, HDMI (registered trademark), or Bluetooth (registered trademark) can be used. The term "HDMI (registered trademark)" is an abbreviation for "High-Definition Multimedia Interface". The in-vehicle device 20 may be connected to various elements via an in-vehicle network such as a CAN. The term "CAN" is an abbreviation for "Controller Area Network". As a modification, the in-vehicle device 20 may itself include the input device 12, the output device 13, or both of these. As another modification, the in-vehicle device 20 may include the physical switch 16 itself.

The configuration of the in-vehicle device 20 according to the present embodiment will be described with reference to FIG. 3.

The in-vehicle device 20 includes a control unit 21, a storage unit 22, and a communicator 23.

The control unit 21 includes at least one processor, at least one programmable circuit, at least one dedicated circuit, or any combination of these. The processor is a general-purpose processor such as a CPU or a GPU, or a dedicated processor specialized for a specific process. The term "CPU" is an abbreviation for "central processing unit". The term "GPU" is an abbreviation for "graphics processing unit". The programmable circuit is, for example, an FPGA. The term "FPGA" is an abbreviation for "field-programmable gate array". The dedicated circuit is, for example, an ASIC. The term "ASIC" is an abbreviation for "application specific integrated circuit". The control unit 21 executes processes related to the operation of the in-vehicle device 20 while controlling the various units of the in-vehicle device 20.

The storage unit 22 includes at least one semiconductor memory, at least one magnetic memory, at least one optical memory, or any combination of these. The semiconductor memory is, for example, a RAM, a ROM, or a flash memory. The term "RAM" is an abbreviation for "random access memory". The term "ROM" is an abbreviation for "read only memory". The RAM is, for example, an SRAM or a DRAM. The term "SRAM" is an abbreviation for "static random access memory". The term "DRAM" is an abbreviation for "dynamic random access memory". The ROM is, for example, an EEPROM. The term "EEPROM" is an abbreviation for "electrically erasable programmable read only memory". The flash memory is, for example, an SSD. The magnetic memory is, for example, an HDD. The storage unit 22 functions as, for example, a main storage device, an auxiliary storage device, or a cache memory. The storage unit 22 stores information to be used for the operation of the in-vehicle device 20 and information obtained by the operation of the in-vehicle device 20.

The communicator 23 includes at least one communication module. The communication module is, for example, a module that supports a mobile communication standard such as LTE, 4G, or 5G, or a wireless LAN communication standard such as IEEE 802.11. The term "LTE" is an abbreviation for "Long Term Evolution". The term "4G" is an abbreviation for "4th generation". The term "5G" is an abbreviation for "5th generation". The term "IEEE" is an abbreviation for "Institute of Electrical and Electronics Engineers". The communicator 23 communicates with the server device 30. The communicator 23 receives information to be used for the operation of the in-vehicle device 20, and transmits information obtained by the operation of the in-vehicle device 20.

The functions of the in-vehicle device 20 are implemented by a processor serving as the control unit 21 by executing a program according to the present embodiment. That is, the functions of the in-vehicle device 20 are implemented by software. The program causes a computer to function as the in-vehicle device 20 by causing the computer to execute the operation of the in-vehicle device 20. That is, the computer functions as the in-vehicle device 20 by executing the operation of the in-vehicle device 20 according to the program.

The program can be stored in a non-transitory computer-readable medium. The non-transitory computer-readable medium is, for example, a flash memory, a magnetic recording device, an optical disc, a magneto-optical recording medium, or a ROM. The program is distributed by, for example, selling, transferring, or renting a portable medium such as an SD card, a DVD, or a CD-ROM in which the program is stored. The term "CD-ROM" is an abbreviation for "compact disc read only memory". The program may be distributed by storing the program in a storage of a server and transferring the program from the server to other computers. The program may be provided as a program product.

The computer temporarily stores the program stored in the portable medium or the program transferred from the server in the main storage device, for example. The computer then causes the processor to read the program stored in the main storage device, and causes the processor to execute processing according to the read program. The computer may read the program directly from the portable medium and execute processing according to the program. Each time the program is transferred from the server to the computer, the computer may successively execute processing according to the program that is received. Processing may be executed by a so-called ASP type service, in which functions are implemented only by making execution instructions and acquiring results, without transferring a program from a server to a computer. The term "ASP" is an abbreviation for "application service provider". The program includes information that is to be provided for processing by an electronic computer and that is equivalent to a program. For example, data that is not a direct command to a computer but has the property of defining processing by the computer corresponds to the "information equivalent to a program".

Some or all of the functions of the in-vehicle device 20 may be implemented by a programmable circuit or a dedicated circuit as the control unit 21. That is, some or all of the functions of the in-vehicle device 20 may be implemented by hardware.

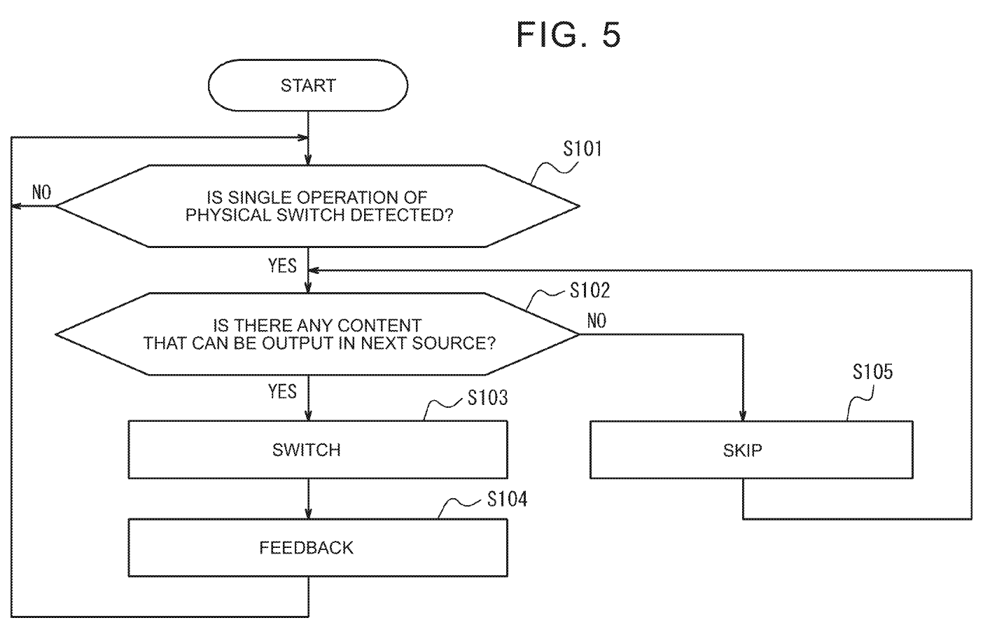

The operation of the in-vehicle device 20 according to the present embodiment will be described with reference to FIG. 5. The operation described below corresponds to the source switching method according to the present embodiment. That is, the source switching method according to the present embodiment includes steps S101 to S105 illustrated in FIG. 5.

Each time the control unit 21 detects a single operation of the physical switch 16 in S101, steps in and after S102 are executed. For example, each time the user 11 performs an operation such as pressing, tilting, or tapping the steering switch 15, the control unit 21 detects the operation of the steering switch 15 by receiving a source switching request from the steering switch 15 via the CAN.

In S102, the control unit 21 specifies the next source according to a switching order set in advance. When the control unit 21 determines that there is any content that can be output in the next source, steps S103 and S104 are executed. When the control unit 21 determines that there is no content that can be output in the next source, step S105 is executed.

In S103, the control unit 21 switches to the next source. In S104, the control unit 21 provides feedback to the user 11. For example, the control unit 21 notifies the user 11 through sound or screen update that switching to the next source has been made. When a content of the source after the switching is selected, the control unit 21 outputs the selected content via the output device 13. When there is any content to be output automatically in the source after the switching, the control unit 21 may automatically output the content via the output device 13 without any notification. After S104, the processes in and after S101 are executed again.

In S105, the control unit 21 skips the next source. After S105, the processes in and after S102 are executed again.

As an example, it is assumed that the source includes a first source, a second source, and a third source. It is assumed that the switching order is determined such that the first source precedes the second source and the second order precedes the third source. Upon detecting a single operation of the physical switch 16 when a content of the first source is being output via the output device 13, the control unit 21 determines whether there is any content that can be output in the second source. When it is determined that there is any content that can be output, the control unit 21 switches to the second source. When it is determined that there is no content that can be output, the control unit 21 skips the second source and switches to the third source or a subsequent source.

For example, when it is assumed that the second source is a content distribution service, and when switching to the second source is made, the control unit 21 receives a content distributed from the server device 30 via the communicator 23 and outputs the received content via the output device 13. When the content distribution service is unavailable, for example, when the content distribution service is not subscribed to or the service of the content distribution service has been suspended, the control unit 21 determines that there is no content that can be output in the second source.

For example, when it is assumed that the second source is the portable medium 17, and when switching to the second source is made, the control unit 21 outputs a content stored in the portable medium 17 via the output device 13. When the portable medium 17 is not connected, the control unit 21 determines that there is no content that can be output in the second source.

In the present embodiment, the behavior of the in-vehicle device 20 at the time when switching the source of a multimedia content such as audio or video is different between when there is no content that can be output and otherwise. Specifically, when the user 11 attempts to switch the source using the physical switch 16 such as the steering switch 15 in the vehicle 10, and when there is no content that can be output in the next source, the next source is skipped and switching is made to the next next source or a subsequent source. On the other hand, when there is any content that can be output in the next source, switching to the next source is made and the content is output manually or automatically. Thus, according to the present embodiment, the source of a content can be sequentially switched using the physical switch 16 in the vehicle 10, and convenience for the user 11 is improved.

Step S105 may be executed only when the vehicle 10 is moving. In other words, when the vehicle 10 is stationary when a single operation of the physical switch 16 is detected in S101, switching to the next source may be made in S103, regardless of whether there is any content that can be output in the next source. For example, the control unit 21 may determine whether the vehicle 10 is moving or stationary based on information that can be acquired from a sensor mounted on the vehicle 10 via the CAN.

When the vehicle 10 is stationary when a single operation of the physical switch 16 is detected in S101, it may be possible to switch not only to the source of a multimedia content but also to an application for gaming, conferencing, or the like.

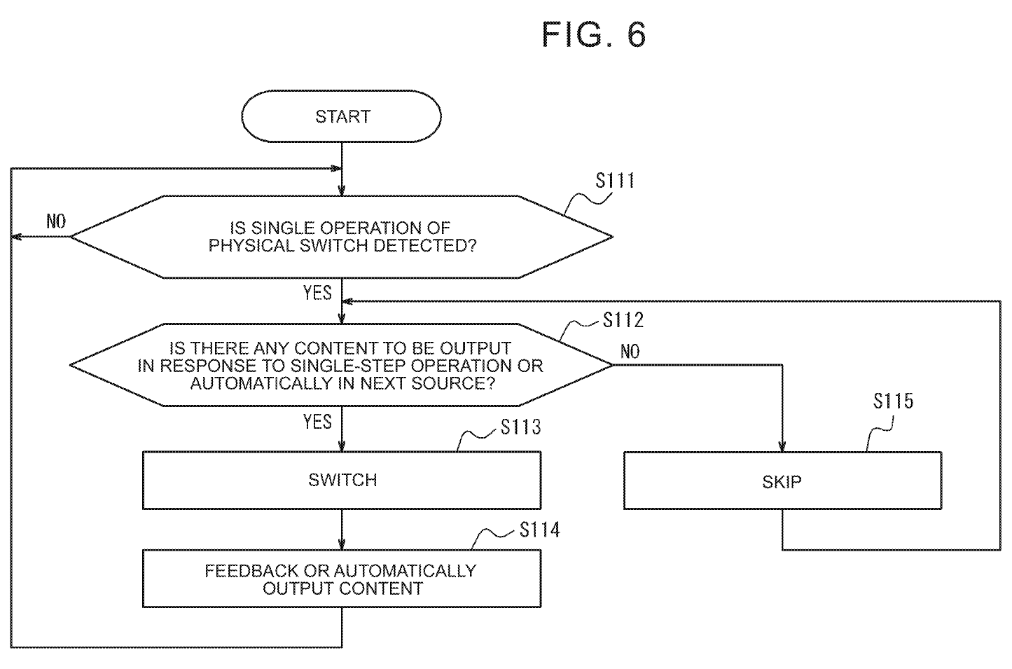

A modification of the operation of the in-vehicle device 20 according to the present embodiment will be described with reference to FIG. 6. The operation described below corresponds to the modification of the source switching method according to the present embodiment. That is, the modification of the source switching method according to the present embodiment includes steps S111 to S115 illustrated in FIG. 6.

Each time the control unit 21 detects a single operation of the physical switch 16 in S111, steps in and after S112 are executed.

In S112, the control unit 21 specifies the next source according to a switching order set in advance. When the control unit 21 determines that there is any content to be output in response to a single-step operation or automatically in the next source, steps S113 and S114 are executed. Unlike step S102 illustrated in FIG. 5, when the control unit 21 determines that there is no content to be output in response to a single-step operation or automatically in the next source, step S115 is executed, even when there is any content that can be output in the next source.

In S113, the control unit 21 switches to the next source. In S114, the control unit 21 provides feedback to the user 11 or automatically outputs a content of the source after the switching. In the former case, for example, the control unit 21 notifies the user 11 through sound or screen update that switching to the next source has been made. When a content of the source after the switching is selected, the control unit 21 outputs the selected content via the output device 13. In the latter case, the control unit 21 automatically outputs the content of the source after the switching via the output device 13 without any notification. After S114, the processes in and after S111 are executed again.

In S115, the control unit 21 skips the next source. After S115, the processes in and after S112 are executed again.

As an example, it is assumed that the source includes a first source, a second source, and a third source. It is assumed that the switching order is determined such that the first source precedes the second source and the second order precedes the third source. Upon detecting a single operation of the physical switch 16 when a content of the first source is being output via the output device 13, the control unit 21 determines whether there is any content to be output in response to a single-step operation or automatically in the second source. When it is determined that there is any content to be output in response to a single-step operation or automatically, the control unit 21 switches to the second source. When it is determined that there is no content to be output in response to a single-step operation or automatically, the control unit 21 skips the second source and switches to the third source or a subsequent source.

For example, when it is assumed that the second source is a content distribution service, and when switching to the second source is made, the control unit 21 receives a content distributed from the server device 30 via the communicator 23 and outputs the received content via the output device 13. When there is any content that can be output by simply touching once a screen of the content distribution service, the control unit 21 determines that there is any content that can be output in response to a single-step operation in the second source. When a continuation of a previously output content of the content distribution service can be output automatically, the control unit 21 determines that there is any content to be output automatically in the second source.

Step S115 may be executed only when the vehicle 10 is moving. That is, when the vehicle 10 is stationary when a single operation of the physical switch 16 is detected in S111, switching to the next source may be made in S113, regardless of whether there is any content to be output in response to a single-step operation or automatically in the next source. Switching to an application for gaming, conferencing, or the like may also be possible.

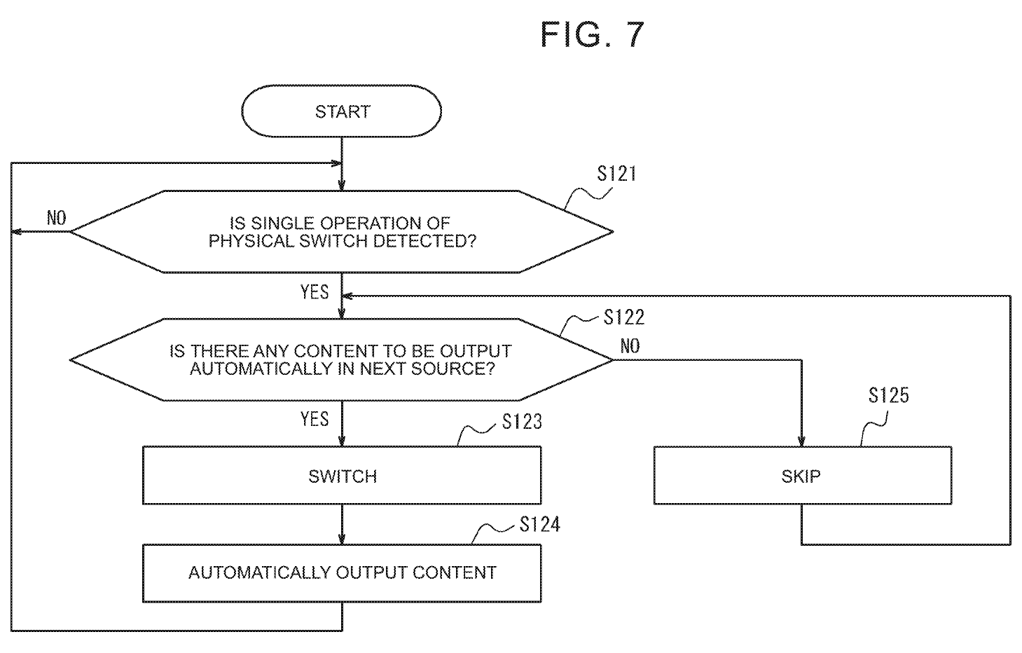

A different modification of the operation of the in-vehicle device 20 according to the present embodiment will be described with reference to FIG. 7. The operation described below corresponds to the different modification of the source switching method according to the present embodiment. That is, the different modification of the source switching method according to the present embodiment includes steps S121 to S125 illustrated in FIG. 7.

Each time the control unit 21 detects a single operation of the physical switch 16 in S121, steps in and after S122 are executed.

In S122, the control unit 21 specifies the next source according to a switching order set in advance. When the control unit 21 determines that there is any content to be output automatically in the next source, steps S123 and S124 are executed. Unlike step S112 illustrated in FIG. 6, when the control unit 21 determines that there is no content to be output automatically in the next source, step S125 is executed, even when there is any content to be output in response to a single-step operation in the next source.

In S123, the control unit 21 switches to the next source. In S124, the control unit 21 automatically outputs the content of the source after the switching via the output device 13. After S124, the processes in and after S121 are executed again.

In S125, the control unit 21 skips the next source. After S125, the processes in and after S122 are executed again.

As an example, it is assumed that the source includes a first source, a second source, and a third source. It is assumed that the switching order is determined such that the first source precedes the second source and the second order precedes the third source. Upon detecting a single operation of the physical switch 16 when a content of the first source is being output via the output device 13, the control unit 21 determines whether there is any content to be output automatically in the second source. When it is determined that there is any content to be output automatically, the control unit 21 switches to the second source. When it is determined that there is no content to be output automatically, the control unit 21 skips the second source and switches to the third source or a subsequent source.

For example, when it is assumed that the second source is a content distribution service, and when switching to the second source is made, the control unit 21 receives a content distributed from the server device 30 via the communicator 23 and outputs the received content via the output device 13. When a continuation of a previously output content of the content distribution service can be output automatically, the control unit 21 determines that there is any content to be output automatically in the second source.

In this modification, the switching target of the physical switch 16 changes dynamically according to the presence or absence of an output content. For example, when there is no content in the middle of being output in the last used source, that source is automatically excluded from the switching target. It is desirable that the switching target be limited to only sources that can automatically output a content with sound. According to this modification, no adverse effects such as silence occur not only when switching is made to a source whose output content is implicitly determined, such as a physical medium such as a CD, but also when switching is made to a source, the presence or absence of whose output content is not fixed, such as a content distribution service.

Step S125 may be executed only when the vehicle 10 is moving. In other words, when the vehicle 10 is stationary when a single operation of the physical switch 16 is detected in S121, switching to the next source may be made in S123, regardless of whether there is any content to be output automatically in the next source. Switching to an application for gaming, conferencing, or the like may also be possible.

The present disclosure is not limited to the embodiment discussed above. For example, two or more blocks illustrated in the block diagram may be integrated, or a single block may be divided. Instead of executing two or more steps illustrated in the flowchart in chronological order according to the description, the steps may be executed in parallel or in a different order, according to the processing capacities of the devices that execute the steps or as necessary. Other changes may be made without departing from the spirit and scope of the present disclosure.

Some embodiments of the present disclosure will be given below. However, it should be noted that the embodiments of the present disclosure are not limited to these.

### Appendix 1

An in-vehicle device installed in a vehicle, including a control unit configured to:
switch a source in a switching order set in advance each time a single operation of a physical switch mounted on the vehicle is detected;
output a content of the source via an output device mounted on the vehicle; and
when switching the source, skip a source that has no outputtable content.

### Appendix 2

The in-vehicle device according to appendix 1, in which:
the source includes a first source, a second source, and a third source;
the switching order is determined such that the first source precedes the second source and the second source precedes the third source; and
the control unit is configured to upon detecting the single operation of the physical switch when a content of the first source is being output via the output device, determine whether there is any outputtable content in the second source, switch to the second source when it is determined that there is any outputtable content, and skip the second source and switch to the third source or a subsequent source when it is determined that there is no outputtable content.

### Appendix 3

The in-vehicle device according to appendix 2, in which:
the second source is a portable medium that is connectable to the in-vehicle device; and the control unit is configured to
output a content stored in the portable medium via the output device when switching to the second source is made, and
determine that there is no outputtable content in the second source when the portable medium is not connected.

### Appendix 4

The in-vehicle device according to any one of appendices 1 to 3, in which when switching the source, the control unit also skips a source that has no content to be output in response to a single-step operation or automatically.

### Appendix 5

The in-vehicle device according to appendix 4, in which:
the source includes a first source, a second source, and a third source;
the switching order is determined such that the first source precedes the second source and the second source precedes the third source; and
the control unit is configured to upon detecting the single operation of the physical switch when a content of the first source is being output via the output device, determine whether there is any content to be output in response to a single-step operation or automatically in the second source, switch to the second source when it is determined that there is any content to be output in response to the single-step operation or automatically, and skip the second source and switch to the third source or a subsequent source when it is determined that there is no content to be output in response to the single-step operation or automatically.

### Appendix 6

The in-vehicle device according to appendix 5, further including a communicator that communicates with a server device that provides a content distribution service, in which:
the second source is the content distribution service; and
the control unit is configured to
when switching to the second source is made, receive a content distributed from the server device via the communicator and output the received content via the output device, and
determine that there is any content to be output in response to the single-step operation in the second source when there is any content that is outputtable by simply touching once a screen of the content distribution service.

### Appendix 7

The in-vehicle device according to appendix 5 or 6, further including a communicator that communicates with a server device that provides a content distribution service, in which:
the second source is the content distribution service; and
the control unit is configured to
when switching to the second source is made, receive a content distributed from the server device via the communicator and output the received content via the output device, and
determine that there is any content to be output automatically in the second source when a continuation of a previously output content of the content distribution service is outputtable automatically.

### Appendix 8

The in-vehicle device according to any one of appendices 1 to 3, in which when switching the source, the control unit also skips a source that has no content to be output automatically.

### Appendix 9

The in-vehicle device according to appendix 8, in which:
the source includes a first source, a second source, and a third source;
the switching order is determined such that the first source precedes the second source and the second source precedes the third source; and
the control unit is configured to upon detecting the single operation of the physical switch when a content of the first source is being output via the output device, determine whether there is any content to be output automatically in the second source, switch to the second source when it is determined that there is any content to be output automatically, and skip the second source and switch to the third source or a subsequent source when it is determined that there is no content to be output automatically.

### Appendix 10

The in-vehicle device according to appendix 9, further including a communicator that communicates with a server device that provides a content distribution service, in which:
the second source is the content distribution service; and
the control unit is configured to
when switching to the second source is made, receive a content distributed from the server device via the communicator and output the received content via the output device, and
determine that there is any content to be output automatically in the second source when a continuation of a previously output content of the content distribution service is outputtable automatically.

### Appendix 11

The in-vehicle device according to any one of appendices 1 to 10, in which the content includes a multimedia content.

### Appendix 12

The in-vehicle device according to any one of appendices 1 to 11, in which the physical switch is a steering switch installed on a steering wheel of the vehicle.

### Appendix 13

A vehicle including the in-vehicle device according to any one of appendices 1 to 11.

### Appendix 14

The vehicle according to appendix 13, further including a steering switch installed on a steering wheel of the vehicle as the physical switch.

### Appendix 15

A program that causes a computer to function as the in-vehicle device according to any one of appendices 1 to 12.

### Appendix 16

A source switching method of switching a source, including:
an in-vehicle device installed in a vehicle switching the source in a switching order set in advance each time a single operation of a physical switch mounted on the vehicle is detected;
the in-vehicle device outputting a content of the source via an output device mounted on the vehicle; and
when switching the source, the in-vehicle device skipping a source that has no outputtable content.

### Appendix 17

The source switching method according to appendix 16, further including when switching the source, the in-vehicle device also skipping a source that has no content to be output in response to a single-step operation or automatically.

### Appendix 18

The source switching method according to appendix 16, further including when switching the source, the in-vehicle device also skipping a source that has no content to be output automatically.

### Appendix 19

The source switching method according to any one of appendices 16 to 18, in which the content includes a multimedia content.

### Appendix 20

The source switching method according to any one of appendices 16 to 19, in which the physical switch is a steering switch installed on a steering wheel of the vehicle.

What is claimed is:

1. An in-vehicle device installed in a vehicle, comprising a processor configured to:
switch a source in a switching order set in advance each time a single operation of a physical switch mounted on the vehicle is detected;
output a content of the source via an output device mounted on the vehicle; and
when switching the source, skip a source that has no outputtable content.

2. The in-vehicle device according to claim 1, wherein:
the source includes a first source, a second source, and a third source;
the switching order is determined such that the first source precedes the second source and the second source precedes the third source; and
the processor is configured to
upon detecting the single operation of the physical switch when a content of the first source is being output via the output device, determine whether there is any outputtable content in the second source;
switch to the second source when it is determined that there is any outputtable content; and
skip the second source and switch to the third source or a subsequent source when it is determined that there is no outputtable content.

3. The in-vehicle device according to claim 2, wherein:
the second source is a portable medium configured to be connected to the in-vehicle device; and
the processor is configured to
output a content stored in the portable medium via the output device when switching to the second source is made, and
determine that there is no outputtable content in the second source when the portable medium is not connected.

4. The in-vehicle device according to claim 1, wherein the processor is configured to, when switching the source, also skip a source that has no content to be output in response to a single-step operation or automatically.

5. The in-vehicle device according to claim 4, wherein:
the source includes a first source, a second source, and a third source;
the switching order is determined such that the first source precedes the second source and the second source precedes the third source; and
the processor is configured to
upon detecting the single operation of the physical switch when a content of the first source is being output via the output device, determine whether there is any content to be output in response to a single-step operation or automatically in the second source,
switch to the second source when it is determined that there is any content to be output in response to the single-step operation or automatically, and
skip the second source and switch to the third source or a subsequent source when it is determined that there is no content to be output in response to the single-step operation or automatically.

6. The in-vehicle device according to claim 5, further comprising a communicator configured to communicate with a server device that provides a content distribution service, wherein:
the second source is the content distribution service; and
the processor is configured to
when switching to the second source is made, receive a content distributed from the server device via the communicator and output the received content via the output device, and
determine that there is any content to be output in response to the single-step operation in the second source when there is any content that is outputtable by simply touching once a screen of the content distribution service.

7. The in-vehicle device according to claim 5, further comprising a communicator configured to communicate with a server device that provides a content distribution service, wherein:
the second source is the content distribution service; and
the processor is configured to
when switching to the second source is made, receive a content distributed from the server device via the communicator and output the received content via the output device, and
determine that there is any content to be output automatically in the second source when a continuation of a previously output content of the content distribution service is outputtable automatically.

8. The in-vehicle device according to claim 1, wherein the processor is configured to, when switching the source, also skip a source that has no content to be output automatically.

9. The in-vehicle device according to claim 8, wherein:
the source includes a first source, a second source, and a third source;
the switching order is determined such that the first source precedes the second source and the second source precedes the third source; and
the processor is configured to
upon detecting the single operation of the physical switch when a content of the first source is being output via the output device, determine whether there is any content to be output automatically in the second source,
switch to the second source when it is determined that there is any content to be output automatically, and
skip the second source and switch to the third source or a subsequent source when it is determined that there is no content to be output automatically.

10. The in-vehicle device according to claim 9, further comprising a communicator configured to communicate with a server device that provides a content distribution service, wherein:
the second source is the content distribution service; and
the processor is configured to
when switching to the second source is made, receive a content distributed from the server device via the communicator and output the received content via the output device, and
determine that there is any content to be output automatically in the second source when a continuation of a previously output content of the content distribution service is outputtable automatically.

11. The in-vehicle device according to claim 1, wherein the content includes a multimedia content.

12. The in-vehicle device according to claim 1, wherein the physical switch is a steering switch installed on a steering wheel of the vehicle.

13. A vehicle comprising the in-vehicle device according to claim 1.

14. The vehicle according to claim 13, further comprising a steering switch installed on a steering wheel of the vehicle as the physical switch.

15. A non-transitory storage medium storing instructions that are executable by one or more processors, the instructions causing the one or more processors to perform the functions of the in-vehicle apparatus according to claim 1.

16. A source switching method of switching a source in an in-vehicle device, the source switching method comprising:
switching the source in a switching order set in advance each time a single operation of a physical switch mounted on a vehicle is detected;
outputting a content of the source via an output device mounted on the vehicle; and
when switching the source, skipping a source that has no outputtable content.

17. The source switching method according to claim 16, further comprising when switching the source, also skipping a source that has no content to be output in response to a single-step operation or automatically.

18. The source switching method according to claim 16, further comprising when switching the source, also skipping a source that has no content to be output automatically.

19. The source switching method according to claim 16, wherein the content includes a multimedia content.

20. The source switching method according to claim 16, wherein the physical switch is a steering switch installed on a steering wheel of the vehicle.
